(19) United States
(12) Patent Application Publication
(10) Pub. No.: US 2005/0012820 A1
(43) Pub. Date: Jan. 20, 2005

(54) Data management process for television assembly

(75) Inventor: Toru Yamakawa, Las Californias Mexicali (MX)

Correspondence Address: ROGITZ & ASSOCIATES, 750 B Street, Suite 3120, San Diego, CA, 92101, US

(73) Assignees: SONY CORPORATION, Toyko (JP); SONY ELECTRONICS INC., Park Ridge, NJ (US)

(21) Appl. No.: 10/801,991

(22) Filed: Mar. 16, 2004

Related U.S. Application Data
(60) Provisional application No. 60/485,049, filed on Jul. 3, 2003.

(51) Int. Cl. H04N 17/02; H04N 5/68

(52) U.S. Cl. 348/189; 348/805

(57) ABSTRACT

Information about various adjustments made to TVs during assembly is entered into a database after each adjustment, instead of after the TV has completed the adjustment line, so that corrective action when appropriate can be taken more quickly.

### RELATED APPLICATIONS

This application claims priority from U.S. provisional patent application Ser. No. 60/485,049, filed Jul. 3, 2003.

### I. FIELD OF THE INVENTION

The present invention relates generally to processes for assembling televisions.

### II. BACKGROUND

In a conventional process for manufacturing a cathode ray tube (“CRT”) monitor, an integrated tube component (“ITC”) is assembled. The ITC includes a CRT, a deflection yoke (“DY”), and typically one or more magnets or permalloy components. The construction and operation of CRTs and DYs are well known in the art. In manufacturing, the DY is mounted on the CRT. The location where an electron strikes the front panel of the CRT is referred to as “landing position.” For desirable performance of the monitor and image quality, electrons in the CRT should have landing positions within defined locations or regions, such as phosphor stripes on the front panel of the CRT. The position of the DY is adjusted during the assembly process as needed, to adjust the landing position of electrons in the CRT. The DY is then fixed in place on the CRT.

In addition to striking desired locations in the CRT, electrons should strike at desired times to provide unified dots of color in the image. When the electrons forming the colors of a dot do not strike the phosphor of the panel within the correct time frames, the colors may not blend properly resulting in a undesirable image. This timing problem is referred to as “misconvergence.” Timing synchronization is referred to as “convergence.” Proper convergence provides a desirable image. Accordingly, magnets can be applied to the CRT, as needed, to adjust convergence in the CRT. In another process, convergence circuitry in the CRT-DY assembly can be employed to adjust convergence using internal data register control. While convergence can be controlled by the CRT-DY assembly, there may be differences between specific CRT-DY assemblies in their performance relative to specified tolerances. For example, variations in material composition or component construction may cause these differences. The above techniques can be used to compensate for these differences and correct the convergence of the monitor.

Additional adjustments can be made during assembly, including adjusting the geometry of the electron beam and adjusting the white balance of the display.

As recognized herein, in conventional assembly processes, information about the adjustments made along the assembly line is not immediately made available to other members of the assembly team. Instead, adjustment data ordinarily is entered manually into a database post-adjustment, at the end of the assembly process. This means that information regarding a potentially defective lot of a particular component or potentially defective (or particularly effective) assembly techniques may be based on a small sample and moreover are not made available to supervisory personnel for potentially lengthy periods of time, preventing the rapid correction of problems by assembly line managers and/or component vendors.

### SUMMARY OF THE INVENTION

A television (TV) assembly process includes recording, in a data structure, bar code information that pertains to at least one component of a TV. The process includes transporting the TV to a landing adjust station, and as necessary, adjusting the landing of the TV. Prior to making other adjustments, information regarding landing adjustments of the TV is stored in the data structure. The TV is then transported to a conversion adjust station in the same facility as the landing adjust station where, as necessary, the conversion of the TV is adjusted. Prior to making other adjustments, the process includes storing information regarding conversion adjustments of the TV in the data structure.

Preferably, in addition to the above process steps the process includes transporting the TV from the conversion adjust station to a white balance adjust station in the same facility as the landing adjust station, and as necessary, adjusting the white balance of the TV. Prior to making other adjustments, information regarding white balance adjustments of the TV is stored in the data structure. Further, the preferred process includes transporting the TV from the white balance adjust station to a geometry adjust station in the same facility as the landing adjust station, and as necessary, adjusting the geometry of the TV. Prior to making other adjustments, information regarding geometry adjustments of the TV is stored in the data structure. Corrective action may be taken in response to information regarding an adjustment prior to making another adjustment.

The non-limiting data structure can include at least one component identification derived from a bar code. Correlated with the component identification is information regarding plural adjustments. The component identification may be a serial number. The data structure can be made accessible over an intranet.

In another aspect, a TV assembly facility includes an assembly station including means for reading bar codes, and means for transmitting bar code information to a data store. A landing adjust station including means for transmitting information related to landing adjustment to the data store is also provided, as is a conversion adjust station including means for transmitting information related to conversion adjustment to the data store.

In still another aspect, a method for assembling televisions (TVs) in a single facility includes sending serial number information related to a TV to a data store, and sending landing adjustment information to the data store. The method also includes correlating the landing adjustment information with the serial number information. Further, the method includes, after the correlating act, sending conversion adjustment information to the data store, and correlating the conversion adjustment information with the serial number information.

In yet another aspect, a data structure for holding TV assembly information includes a TV identification column, at least one component serial number column storing serial numbers of components associated with TVs identified in the TV identification column, and plural adjustment information columns correlating information regarding various adjustments with associated TV and component information.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of the present process flow;

FIG. 2 is a schematic diagram of an exemplary data structure; and

FIG. 3 is a flow chart of the inventive logic.

### DETAILED DESCRIPTION OF THE PREFERRED EMBODIMENT

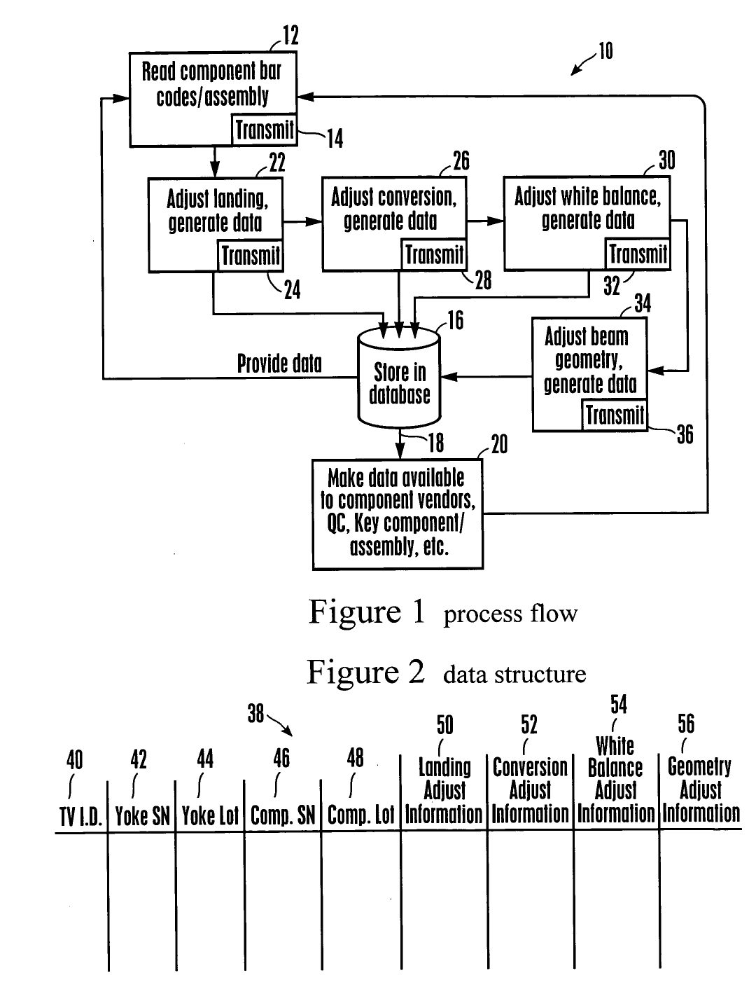

Referring initially to FIG. 1, a system is shown, generally designated 10, for assembling TVs preferably in a single facility. The TVs can be cathode ray tube TVs, flat panel TVs, plasma TVs, etc.

As shown, the system 10 includes an assembly line that has at least one assembly/bar code reader station 12 where components of a TV are assembled while reading (with, e.g., a conventional bar code reader that is part of the assembly station 12) their bar codes, which can indicate component serial number, lot number, manufacturer, etc. The serial numbers read may be serial numbers of, e.g., the deflection yoke used in the TV, the printed wire board used, the CRT used, etc.

The TV itself may have a TV identification. In any case, the bar code information is sent by a wired or wireless transmitter 14, such as a computer modem, etc. to a data store 16, which can be a relational database or file system. The data store 16 is accessible over an intranet 18 to managers, component vendors, quality control personnel, etc. 20 for purposes to be shortly disclosed.

After assembling the TV and sending the bar code information to the data store 16, the TV is transported to a landing adjust station 22, where the landing of the TV is adjusted as necessary in accordance with principles known in the art. Information regarding the characteristics of the landing adjustment is sent by a wired or wireless transmitter 24 to the data store 16. According to the present invention, adjustment information can be manually or automatically loaded into a processor associated with an adjustment station for transmission to the data store 16.

After or simultaneously with sending the landing adjustment information to the data store 16, the TV is transported to a conversion adjust station 26, where the conversion of the TV is adjusted as necessary in accordance with principles known in the art. Information regarding the characteristics of the conversion adjustment is sent by a transmitter 28 to the data store 16.

After or simultaneously with sending the conversion adjustment information to the data store 16, the TV is transported to a white balance adjust station 30, where the white balance the TV is adjusted as necessary in accordance with principles known in the art. Information regarding the characteristics of the white balance adjustment is sent by a transmitter 32 to the data store 16.

After or simultaneously with sending the white balance adjustment information to the data store 16, the TV is transported to a electron beam geometry adjust station 34, where the electron beam geometry the TV is adjusted as necessary in accordance with principles known in the art. Information regarding the characteristics of the electron beam geometry adjustment is sent by a transmitter 36 to the data store 16.

With the above inventive concepts, real time data regarding assembly line performance and component batch quality is made available to both assembly line managers and component suppliers 20, integrating the production enterprise and increasing picture quality and maintenance response while reducing adjustment cycle time and assembly delays. That is, the entities 20 can immediately effect corrective action before a particular TV has completed the adjustment process by, e.g., replacing a defective lot of deflection yokes at the assembly station 12 immediately after landing adjustment, or by warning assembly line personnel (at, e.g., the assembly station 12) of defective assembly practices based on excessive adjustments before all adjustments are made. Such warnings may be generated when components require adjustment to remain within a six-sigma (6-) tolerance band.

FIG. 2 shows a data structure 38 that can be used to store the information discussed above in the data store 16. The data structure 38 may be implemented, e.g., in a file system spreadsheet or by one or more tables in relational database.

As shown, the data structure 38 can include a TV identification column 40 that can be populated by serial number information read from bar codes on a TV chassis or CRT at the assembly station 12. Other columns having information populated by reading bar codes at the assembly station 12 can include a deflection yoke serial number column 42 and if desired a deflection yoke lot number column 44, representing the manufacturer's lot number. This information can be used to identify a potentially defective lot of deflection yokes. Additional component serial number and lot number columns 46, 48 can be provided to store serial numbers and lot numbers of, e.g., printed wire boards associated with the TV ID in column 40, etc.

Continuing the description of the exemplary data structure 38 shown in FIG. 2, adjustment information columns 50-56 can be provided to correlate information regarding various adjustments with associated TV and component information in columns 40-48. More specifically, a landing adjustment information column 50 can be populated with information related to adjustments made to the TV identified in column 40 at the landing adjustment station 22. Also, a conversion adjustment information column 50 can be populated with information related to adjustments made to the TV identified in column 40 at the conversion adjustment station 26. Further, a white balance adjustment information column 50 can be populated with information related to adjustments made to the TV identified in column 40 at the white balance adjustment station 30. And, an electron beam geometry adjustment information column 50 can be populated with information related to adjustments made to the TV identified in column 40 at the electron beam geometry adjustment station 34.

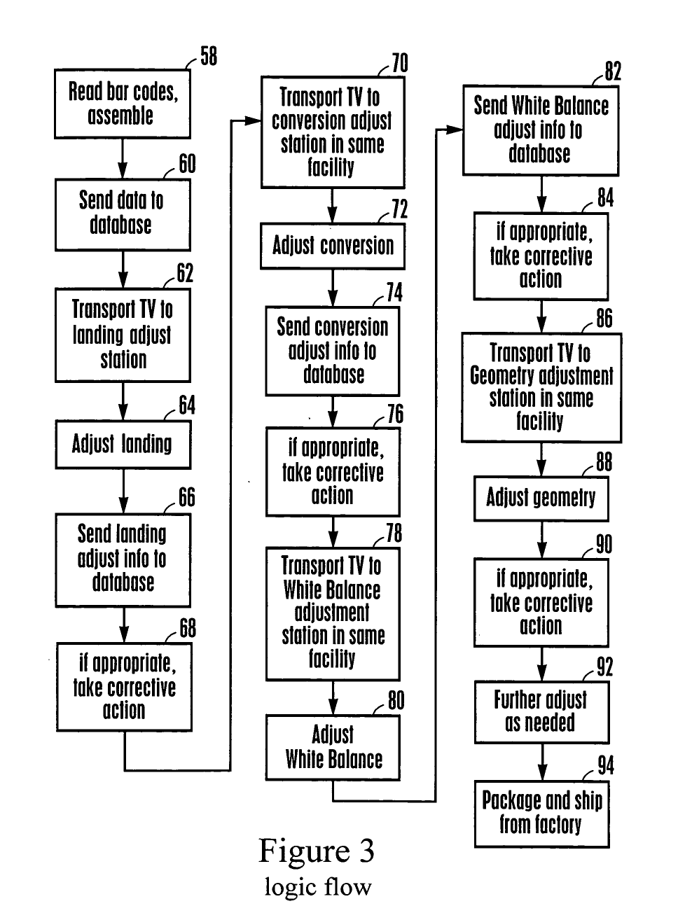

Now referring to FIG. 3, for each TV being assembled, at block 58 the bar codes of the TV and the above-mentioned components are read as the TV is assembled. At block 60, the data is immediately sent to the data store 16 for storage in the data structure 38. Then, at block 62 the TV is transported to the landing adjust station 22.

Proceeding to block 64, the landing is adjusted as necessary, and information related to the landing adjustment preferably is immediately sent to the data store 16 at block 66 for storage in the data structure 38. If needed, corrective action may be taken at block 68. For instance, if adjustment was necessary to bring the landing within, e.g., a six-sigma tolerance band, the lot of the deflection yoke may be inspected, particularly if several TVs in a row violate the six-sigma band. Or, an alarm might sound. Personnel training may be implemented. Still further, since the data is immediately available to vendors 20 accessing the data store 16, the vendor of, e.g., faulty deflection yokes is immediately alerted to defects.

Once the landing adjustment information is sent to the data store 16 and/or once corrective action is taken, the logic moves to block 70, wherein the TV is transported to the conversion adjust station 26, usually in the same facility as the landing adjust station 22. Proceeding to block 72, the conversion is adjusted as necessary, and information related to the conversion adjustment preferably is immediately sent to the data store 16 at block 74 for storage in the data structure 38. If needed, corrective action may be taken at block 76.

Once the conversion adjustment information is sent to the data store 16 and/or once corrective action is taken, the logic moves to block 78, wherein the TV is transported to the white balance adjust station 30, usually in the same facility as the landing adjust station 22. Proceeding to block 80, the white balance is adjusted as necessary, and information related to the white balance adjustment preferably is immediately sent to the data store 16 at block 82 for storage in the data structure 38. If needed, corrective action may be taken at block 84.

Once the white balance adjustment information is sent to the data store 16 and/or once corrective action is taken, the logic moves to block 86, wherein the TV is transported to the electron beam geometry adjust station 34, usually in the same facility as the landing adjust station 22. Proceeding to block 88, the geometry is adjusted as necessary, and information related to the geometry adjustment preferably is immediately sent to the data store 16 for storage in the data structure 38. If needed, corrective action may be taken at block 90. Block 92 indicates that further adjustments may be undertaken as necessary, and then the TV is packaged and shipped from the facility 10 at block 94.

While the particular DATA MANAGEMENT PROCESS FOR TELEVISION ASSEMBLY as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. Absent express definitions herein, claim terms are to be given all ordinary and accustomed meanings that are not irreconcilable with the present specification and file history.

1. A television (TV) assembly process, comprising:
recording, in a data structure, bar code information pertaining to at least one component of a TV;
transporting the TV to a landing adjust station;
as necessary, adjusting the landing of the TV;
prior to making other adjustments, storing information regarding landing adjustments of the TV in the data structure;
transporting the TV to a conversion adjust station in the same facility as the landing adjust station;
as necessary, adjusting the conversion of the TV; and
prior to making other adjustments, storing information regarding conversion adjustments of the TV in the data structure.

2. The process of claim 1, further comprising:
transporting the TV from the conversion adjust station to a white balance adjust station in the same facility as the landing adjust station;
as necessary, adjusting the white balance of the TV; and
prior to making other adjustments, storing information regarding white balance adjustments of the TV in the data structure.

3. The process of claim 2, further comprising:
transporting the TV from the white balance adjust station to a geometry adjust station in the same facility as the landing adjust station;
as necessary, adjusting the geometry of the TV; and
prior to making other adjustments, storing information regarding geometry adjustments of the TV in the data structure.

4. The process of claim 1, comprising taking corrective action in response to information regarding an adjustment prior to making another adjustment.

5. The process of claim 1, wherein the data structure includes:
at least one component identification derived from a bar code;
correlated with the component identification, information regarding plural adjustments.

6. The process of claim 5, wherein the component identification is a serial number.

7. The process of claim 1, wherein the data structure is accessible over an intranet.

8. A TV assembly facility, comprising:
at least one assembly station including means for reading bar codes;
at least one means for transmitting bar code information to a data store;
at least one landing adjust station including means for transmitting information related to landing adjustment to the data store; and
at least one conversion adjust station including means for transmitting information related to conversion adjustment to the data store.

9. The facility of claim 8, wherein all stations are located in a single facility.

10. The facility of claim 8, further comprising:
at least one white balance adjust station including means for transmitting information related to white balance adjustment to the data store; and
at least one geometry adjust station including means for transmitting information related to geometry adjustment to the data store.

11. The facility of claim 8, wherein the data store is accessible over an intranet.

12. The facility of claim 8, wherein the data store includes:
at least one component identification derived from a bar code;
correlated with the component identification, information regarding plural adjustments.

13. The facility of claim 8, wherein each means for transmitting information transmits information no later than the TV moving to a next station.

14. A method for assembling televisions (TVs) in a single facility, comprising:
sending serial number information related to a TV to a data store;
sending landing adjustment information to the data store;
correlating the landing adjustment information with the serial number information;
after the correlating act, sending conversion adjustment information to the data store; and
correlating the conversion adjustment information with the serial number information.

15. The method of claim 14, further comprising:
sending white balance adjustment information to the data store; and
correlating the white balance adjustment information with the serial number information.

16. The method of claim 14, further comprising:
sending geometry adjustment information to the data store; and
correlating the geometry adjustment information with the serial number information.

17. The method of claim 14, wherein the data store is accessible over an intranet.

18. The method of claim 14, wherein the data store includes:
at least one component identification derived from a bar code;
correlated with the component identification, information regarding plural adjustments.

19. A data structure for holding TV assembly information, comprising:
at least one TV identification column;
at least one component serial number column storing serial numbers of components associated with TVs identified in the TV identification column; and
plural adjustment information columns correlating information regarding various adjustments with associated TV and component information.

20. The data structure of claim 19, wherein the adjustment information columns include at least one landing adjustment information column populated with information related to adjustments made to a TV identified in the TV identification column.

21. The data structure of claim 19, wherein the adjustment information columns include at least one conversion adjustment information column populated with information related to adjustments made to a TV identified in the TV identification column.

22. The data structure of claim 19, wherein the adjustment information columns include at least one white balance adjustment information column populated with information related to adjustments made to a TV identified in the TV identification column.

23. The data structure of claim 19, wherein the adjustment information columns include at least one geometry adjustment information column populated with information related to adjustments made to a TV identified in the TV identification column.

24. The data structure of claim 19, wherein the TV identification column and component serial number column are populated by serial number information read from bar codes.

25. The data structure of claim 19, wherein the component serial number column stores serial numbers of deflection yokes.

26. The data structure of claim 19, wherein the component serial number column stores serial numbers of printed wiring boards.

27. A data structure for holding TV assembly information, comprising:
at least one TV identification column;
at least a first component serial number column storing serial numbers of deflection yokes;
at least a second component serial number column storing serial numbers of printed wiring boards;
at least one landing adjustment information column populated with information related to adjustments made to a TV identified in the TV identification column;
at least one conversion adjustment information column populated with information related to adjustments made to a TV identified in the TV identification column;
at least one white balance adjustment information column populated with information related to adjustments made to a TV identified in the TV identification column; and
at least one geometry adjustment information column populated with information related to adjustments made to a TV identified in the TV identification column.
